(19) United States
(12) Patent Application Publication
(10) Pub. No.: US 2002/0007909 A1
(43) Pub. Date: Jan. 24, 2002

(54) Process for the manufacturing of an improved decorative laminate and a decorative laminate obtained by the process

(76) Inventors: Laurence Mott, Trelleborg (SE); Roger Hwatz, Grabo (SE)

Correspondence Address: STEVENS, DAVIS, MILLER & MOSHER, L.L.P., Suite 850, 1615 L Street, N.W., Washington, DC, 20036, US

(21) Appl. No.: 09/902,486

(22) Filed: Jul. 11, 2001

Related U.S. Application Data
(60) Provisional application No. 60/217,017, filed on Jul. 11, 2000.

(51) Int. Cl. C09J 5/02

(52) U.S. Cl. 156/307.3

(57) ABSTRACT

A process for the manufacturing of floor elements, which floor elements comprises an upper decorative surface a lower surface, edges intended for joining and a core forming a carrying structure. At least a first surface web or a number of first surface webs and possibly a second surface web or a number of second surface webs is fed between the belts of a continuous belt press. A mixture of polyols, such as polyester or polyether, crude methylene diphenyl diisocyanate and possibly a small amount of blowing agent in a ratio forming a polymeric resin with a density in the range 600-1400kg/m³ is then applied between the first surface web and the optional second surface web while being fed in between the belts of the continuous belt press. The belts are arranged to allow a mainly uniform and specified material thickness to form, whereby a slightly porous or solid polyurethane core is formed and possibly bonded to the first surface web and possibly the optional second web. The received plate is then cut into boards or tiles and provided with edges comprising joining means such as tongue, groove or the like whereby an abrasion, impact and moisture resistant floor element is achieved.

### CROSS-REFERENCE TO RELATED APPLICATIONS

This application claims the benefit of provisional application serial number 60/217,017, filed Jul. 11, 2000, the entire disclosure of which is herein incorporated by reference.

### BACKGROUND OF THE INVENTION

1. Field of the Invention

A process for the manufacturing of an improved decorative laminate and a decorative laminate obtained by the process.

The present invention relates to a process for manufacturing a decorative laminate and a decorative laminate obtained by the process.

2. Description of the Related Art

Products clad with thermosetting laminates are quite common nowadays. They are most often used where the demand for abrasion resistance is great, but also where resistance towards different chemical substances and moisture is required. Floors, floor skirtings, work tops, table tops, doors and wall panels can serve as an example of such products. The thermosetting laminate is most often made from a number of base sheets and a decorative sheet placed closest to the surface. The decorative sheet may be provided with the desired decor or pattern. Thicker laminates are often provided with a core of particle board or fibre board where both sides are covered with sheets of thermosetting laminate. The outermost sheet is, on at least one side, most often a decorative sheet.

One problem with such thicker laminates is that the core is much softer than the surface layer which is made from paper impregnated with thermosetting resin. This will cause a considerably reduced resistance towards thrusts and blows compared to a laminate with a corresponding thickness made of paper impregnated with thermosetting resin only.

Another problem with thicker laminates with a core of particle board or fibre board is that these normally will absorb a large amount of moisture, which will cause them to expand and soften whereby the laminate will warp. The surface layer might even, partly or completely come off in extreme cases since the core will expand more than the surface layer. This type of laminate product can therefore not be used in humid areas, such as bath rooms or kitchens, without problem.

The problems can be partly solved by making the core of paper impregnated with thermosetting resin as well. Such a laminate is most often called compact laminate. These compact laminates are, however, very expensive and laborious to obtain as several tens of layers of paper have to be impregnated, dried and put in layers. The direction of the fibre in the paper does furthermore cause a moisture and temperature difference relating expansion. This expansion is two to three times as high in the direction crossing the fibre than along the fibre. The longitudinal direction of the fibre is coinciding with the longitudinal direction of the paper. One will furthermore be restricted to use cellulose as a base in the manufacturing though other materials could prove suitable.

### SUMMARY OF THE INVENTION

The above problems have through the present invention been solved whereby a flexible process for the manufacturing of a mainly isometric thermosetting laminate has been achieved where floor elements with radically improved impact resistance, rigidity, moisture resistance is achieved. Accordingly the invention relates to a process for the manufacturing of floor elements, which floor elements comprises an upper decorative surface a lower surface, edges intended for joining and a core forming a carrying structure. The invention is characterised in that;

i) A first surface web or a number of first surface webs and possibly a second surface web or a number of second surface webs is fed between the belts of a continuous belt press.

ii) A mixture of polyols, such as polyester or polyether, crude methylene diphenyl diisocyanate and possibly a small amount of blowing agent in a ratio forming a polymeric resin with a density in the range 600-1400 kg/m³ is thereby applied between the first surface web and the optional second surface web while being fed in between the belts of the continuous belt press. The belts allows a mainly uniform and specified material thickness to form, whereby a slightly porous or solid polyurethane core is formed and possibly bonded to the first surface web and possibly the optional second web.

iii) The received plate is then cut into boards or tiles and provided with edges comprising joining means such as tongue, groove or the like whereby an abrasion, impact and moisture resistant floor element is achieved.

A flame retardant comprising for example halogens such as tri-chlorophosphate is preferably included in the mixture forming the core.

### DETAILED DESCRIPTION OF THE PREFERRED EMBODIMENTS

Suitable is ocyanate-reactive compounds to be used in the process of the present invention which include any of those known in the art for the preparation of rigid polyurethane or urethane-modified polyisocyanurate foams. Of particular importance for the preparation of rigid foams are polyols and polyol mixtures having average hydroxyl numbers of from 100 to 1000, especially from 100 to 700 mg KOH/g, and hydroxyl functionalities of from 2 to 8, especially from 3 to 8. Suitable polyols have been fully described in the prior art and include reaction products of alkylene oxides, for example ethylene oxide and/or propylene oxide, with initiators containing from 2 to 8 active hydrogen atoms per molecule. Suitable initiators include: polyols, for example glycerol, sorbitol, sucrose, triethanolamine, 2-hydroxyalkyl-1, 3-propanediols, 2-hydroxyalkyl-2-alkyl-1, 3-propanediols, 2,2-hydroxyalkyl-1,3-propanediols, 2-hydroxyalkyloxy-1,3-propanediols, 2-hydroxyalkoxy-2-alkyl-1,3-propanediols and 2,2-hydroxyalkoxy-1,3-propanediols, such as trimetylolethane, trimethylolpropane and pentaerythritol, as well as dimers, trimers and polymers thereof; polyamines, for example ethylene diamine, tolylene diamine (TDA), diamino diphenylmethane (DADPM) and polymethylene polyphenylene polyamines; and aminoalcohols, for example ethanolamine and diethanolamine, and mixtures of such initiators. Other suitable polymeric polyols include polyesters obtained by the condensation of appropriate proportions of glycols and higher functionality polyols with dicarboxylic or polycarboxylic acids. Still further suitable polymeric polyols include hydroxyl terminated polythioethers, polyamides, polyesteramides, polycarbonates, polyacetals, polyolefins, polysiloxanes and starbranched, hyperbranched and dendritic polyester and polyether alcohols.

Suitable organic polyisocyanates for use in the process of the present invention include any of those known in the art for the preparation of rigid polyurethane or urethane-modified polyisocyanurate foams, and in particular the aromatic polyisocyanates such as diphenylmethane diisocyanate in the form of its 2,4′, 2,2, and 4,4′ isomers and mixtures thereof, the mixtures of diphenylmethane diisocyanates (MDI) and oligomers thereof known in the art as “crude” or polymeric MDI (polymethylene polyphenylene polyisocyanates) having an isocyanate functionality of greater than 2, toluene diisocyanate in the form of its 2,4 and 2,6 isomers and mixtures thereof, 1,5 naphthalene diisocyanate and 1,4 diisocyanatobenzene. Other organic polyisocyanates which may be mentioned include the aliphatic diisocyanates such as isophorone diisocyanate, 1,6 diisocyanatohexane and 4,4′ diisocyanato-dicyclohexylmethane.

The quantities of the polyisocyanate compositions and the polyfunctional isocyanate-reactive compositions to be reacted will depend upon the nature of the quantities of the polyisocyanate compositions and the polyfunctional isocyanate-reactive compositions to be reacted will depend uponthe nature of the rigid polyurethane or urethane-modifiedpolyisocyanurate foam to be produced and will be readily determined by those skilled in the art.

The water captured in the raw materials (especially the polyols) can be used as blowing agent, when properly monitored. Otherwise, the polyol stream needs to be desiccated before micro-dosing a blowing agent commonly used. Blowing agents proposed in the prior art include hydrochlorofluorocarbons, hydrofluorocarbons and especially hydrocarbons namely alkanes and cycloalkanes such as isobutane, n-pentane, isopentane, cyclopentane and mixtures thereof as well as water or any other carbon dioxide-evolving compounds.

In addition to the polyisocyanate and polyfunctional isocyanate-reactive compositions and the blowing agent mixture, the foam-forming reaction mixture will commonly contain one or more other auxiliaries or additives conventional to formulations for the production of rigid polyurethane and urethane-modified polyisocyanurate foams. Such optional additives include crosslinking agents, for example low molecular weight polyols such as triethanolamine, foam-stabilising agents or surfactants, for example siloxane-oxyalkylene copolymers, urethane catalysts, for example tin compounds such as stannous octoate or dibutyltin dilaurate or tertiary amines such as dimethylcyclohexylamine or triethylene diamine, isocyanurate catalysts, fire retardants, for example halogenated alkylphosphates such as tris chloropropyl phosphate, color pigmentation and fillers such as carbon black.

It is also possible to adapt the mechanical properties of the material by adding other materials such as particles or fibre, These type of additives can be used for a number of reasons. Additives may be used to alter, adjust or improve acoustic properties, density, thermal coefficient of expansion, thermal conductivity, flexibility, rigidity and brittleness. A proper filler may also reduce the manufacturing costs. Typical particle fillers are minerals such as mica and lime, while common fibre fillers are glass, carbon, steel, aramide and cellulose fibres.

According to an embodiment of the invention, the first surface webs, constituting a decorative upper surface, is manufactured by laminating at least one uppermost so-called overlay web of melamine-formaldehyde resin impregnated α-cellulose paper with at least one decorative web of decorated melarnine-formaldehyde resin impregnated a-cellulose paper and possibly a group of support webs under heat and pressure so that the resin cures at least partially and the are bonded to one another, preferably while the polurethane core is formed.

Support layer webs are preferably forming apart of the decorative upper surface. This group of support layer webs then comprises one or more monochromatic webs of α-cellulose impregnated with melamine-formadehyde resin and/or one or more Kraft-paper webs impregnated with phenol-formaldehyde resin, urea- formaldehyde resin, melamine -formaldehyde resin or combinations thereof.

In order to improve abrasion resistance the overlay webs and optionally the decorative paper webs preferably includes 2-100 g/m² per layer of hard particles of α-aluminum oxide, silicon carbide or silicon oxide having an average particle size in the range 50 nm-150 μm. Scratch resistance may be improved by applying 2-100 g/m² of hard particles of α-aluminum oxide, silicon carbide or silicon oxide having an average particle size in the range 50 nm-30 μm on the upper surface of the uppermost overlay web.

The decorative upper surface is possibly laminated and at least partially cured prior to the part of the process where the core is achieved and bonded to the decorative upper surface. It is then preferable to increase the pressure in the press towards the end of pressing cycle.

According to another embodiment of the invention the first surface web is constituted by a printed foil. This printed foil is possibly made of α-cellulose impregnated with a polymeric lacquer or resin such as melamine-formaldehyde, urea-formaldehyde acrylic, maleamid, polyurethane or the like. The printed foil may also be made of a polymer such as polyvinyl-chloride, polyester, polypropylene, polyethylene, polyurethane, acrylic or the like.

The upper surface is then preferably coated with one or more wear-resistant layers of acrylic or maleamid lacquer on top of the printed foil after having passed through the continuous belt press. This lacquer is preferably of an UV- or electron-beam curing type. Such a lacquer is preferably applied in two or more layers with intermediate stages of partial or complete curing. In order to improve the abrasion resistance even further the lacquer may include 2-100 g/m² per layer of hard particles of α-aluminum oxide, silicon carbide or silicon oxide having an average particle size in the range 50 nm-150 μm. These particles may be mixed with the lacquer prior to the coating and or sprinkled on top of a still fluid coating. An improved scratch resistance is obtained by applying 2-100 g/m² of hard particles of α-aluminum oxide, silicon carbide or silicon oxide having an average particle size in the range 50 mn-30 μm on the upper surface of the uppermost layer of lacquer.

According to yet another embodiment of the invention the first surface web is constituted by a translucent or semi-translucent layer and that particles with sizes in the range 0.5-10 mm are applied between the first and the second optional surface web together with the polymeric resin. These particles are preferably deviating in colour from the polymeric resin. To further increase the design options the polymeric resin may also comprises pigmentation.

The semi-translucent layer is possibly constituted of a foil or a web which is provided with a printed decor. The printed decor is suitably semi-translucent. It is also possible to use a printed decor which is opaque, covering only parts of the surface of the foil or web. Such a semi translucently decorated foil or web will increase the image of depth in the decorative upper surface. The semi-translucent foil or web is suitably constituted of a-cellulose impregnated with a polymeric resin or lacquer such as melamine-formaldehyde, urea-formaldehyde, polyurethane, acrylic or maleamide. It may also be constituted of a polymer such as polyvinyl-chloride acrylic, polyester, polypropylene, polyethylene, polyurethane or the like.

To increase the wear resistance a wear layer or a number of wear layers are suitably applied on top of the foil or web. These wear layers are suitably constituted of α-cellulose impregnated with a polymeric resin or lacquer such as melamine-formaldehyde, urea-formaldehyde, polyurethane, acrylic or maleamide. The wear layers may also be constituted of a lacquer such as acrylic or maleamide, possibly of a UV- or electron-beam curing type. Such energy curable lacquers are suitably applied in two or more layers with intermediate stages of partial or complete curing.

To further increase the abrasion resistance the lacquer preferably includes 2-100 g/m² per layer of hard particles of a-aluminum oxide, silicon carbide or silicon oxide having an average particle size in the range 50 nm-150 μm. The scratch resistance can be increased by applying 2-100 g/m² of hard particles of α-aluminum oxide, silicon carbide or silicon oxide having an average particle size in the range 50nm-30 μm on the upper surface of the uppermost layer of lacquer.

According to yet another embodiment of the invention a decor is applied on the upper side of the first surface web or the upper side of the core. The decor is printed directly on the surface or applied on the surface via transfer printing. A wear layer or a number of wear layers are preferably applied on top of the decor. The wear layers are suitably constituted of α-cellulose impregnated with a polymeric resin or lacquer such as melamine-formaldehyde, urea-formaldehyde, polyurethane, acrylic or maleamid. The wear layers may also be constituted of a lacquer such as acrylic or maleamide, possibly of a UV- or electron-beam curing type. Such energy curable lacquer is suitably applied in two or more layers with intermediate stages of partial or complete curing. To increase the wear resistance, 2-100 g/m² per layer of hard particles of α-aluminum oxide, silicon carbide or silicon oxide having an average particle size in the range 50 nm-150 μm, are added. To increase the scratch resistance 2-100 g/m² of hard particles of a-aluminum oxide, silicon carbide or silicon oxide having an average particle size in the range 50 nm-30 μm maybe applied on the upper surface of the uppermost layer of lacquer.

We claim:

1. A process for the manufacturing of floor elements, which floor elements comprises an upper decorative surface and a lower surface, edges intended for joining the floor elements together into a floor and a core forming a carrying structure, comprising; i) feeding at least a first surface web or a number of first surface webs and optionally a second surface web or a number of second surface webs between the belts of a continuous belt press; ii) applying a mixture of polyols, and optionally a small amount ofblowing agent in a ratio forming a polymeric resin with a density in the range 600-1400 kg/m³between the at least first surface web and the optional second surface web while being fed in between the belts of the continuous belt press, allowing the belts to maintain a uniform and specified material thickness to form, whereby a slightly porous or solid polyurethane core is formed which is optionally bonded to the at least first surface web and optionally to the optional second web; iii) and cutting the product produced by step (ii) into boards or tiles and providing edges comprising joining means on said edges whereby an abrasion, impact and moisture resistant floor element is achieved.

2. A process according to claim 1, further including a flame retardant in the mixture.

3. A process according to claim 1, wherein the at least first surface web constitutes a decorative upper surface and is manufactured by laminating at least one uppermost so-called overlay web of melamine-formaldehyde resin impregnated α-cellulose paper with at least one decorative web of decorated melamine-formaldehyde resin impregnated α-cellulose paper and optionally a group of support webs under heat and pressure so that the resin cures at least partially and the webs are bonded to one another.

4. A process according to claim 3, wherein the support layer webs form a part of the decorative upper surface, and wherein the group of support layer webs comprises one or more monochromatic webs of α-cellulose impregnated with melamine-formadehyde resin and/or one or more Kraft-paper webs impregnated with phenol-formaldehyde resin, urea-formaldehyde resin, melamine-formaldehyde resin or combinations thereof.

5. A process according to claim 3, wherein the overlay webs and optionally the decorative paper webs includes 2-100 g/m² per layer of hard particles of a-aluminum oxide, silicon carbide or silicon oxide having an average particle size in the range 50 nm-150 μm.

6. A process according to claim 5, wherein the upper surface of the uppermost overlay web contains 2-100 g/m² of hard particles of a-aluminum oxide, silicon carbide or silicon oxide having an average particle size in the range 50 μm -30 μm.

7. A process according to claim 3, including the steps of laminating the decorative upper surface and at least partially curing the same prior to the part of the process where the core is achieved and bonded to the decorative upper surface.

8. A process according to claim 1, including the stop of increasing the pressure in the belt press towards the end of pressing cycle.

9. A process according to claim 1, wherein the first surface web is constituted by a printed foil.

10. A process according to claim 9, wherein the printed foil is made of α-cellulose impregnated with a polymeric lacquer or resin selected from the group consisting of melamine-formaldehyde, urea-formaldehyde acrylic, maleamid, polyurethane and mixtures thereof.

11. A process according to claim 9, wherein the printed foil is made of a polymer selected from the group consisting of polyvinyl-chloride, polyester, polypropylene, polyethylene, polyurethane, acrylic and mixtures thereof.

12. A process according to claim 9, further comprising coating the upper surface with one or more wear-resistant layers of acrylic or maleamid lacquer on top of the printed foil after having passed through the continuous belt press.

13. A process according to claim 12, including the steps of exposing the lacquer to UV- or electron-beam radiation.

14. A process according to claim 12, including applying the lacquer in two or more layers with intermediate stages of partial or complete curing.

15. A process according to claim 9, wherein the lacquer includes 2-100 g/m² per layer of hard particles of α-aluminum oxide, silicon carbide or silicon oxide having an average particle size in the range 50 nm-150 μm.

16. A process according to claim 15, wherein the upper surface of the uppermost layer of lacquer contains 2-100 g/m² of hard particles of α-aluminum oxide, silicon carbide or silicon oxide having an average particle size in the range 50 nm-30 μm.

17. A process according to claim 1, wherein the first surface web is constituted by a translucent or semi-translucent layer and that particles with sizes in the range 0.5-10 mm are applied between the at least first and the second optional surface web together with the polymeric resin.

18. A process according to claim 17, wherein the particles deviate in color from the polymeric resin.

19. A process according to claim 17, wherein the polymeric resin also comprises pigmentation.

20. A process according to claim 17, wherein the semi-translucent layer is constituted of a foil or a web which is provided with a printed decor.

21. A process according to claim 20, wherein the printed decor is semi-translucent.

22. A process according to claim 20, wherein the printed decor is opaque, covering only parts of the surface of the foil or web.

23. A process according to claim 17, wherein the semi-translucent foil or web is constituted of α-cellulose impregnated with a polymeric resin or lacquer selected from the group consisting of melamine-formaldehyde, urea-formaldehyde, polyurethane, acrylic or maleamide.

24. A process according to claim 17, wherein the semi-translucent foil or web is constituted of a polymer selected from the group consisting of polyvinyl-chloride acrylic, polyester, polypropylene, polyethylene, polyurethane and mixtures thereof.

25. A process according to claim 17, including the step of applying a wear layer or a number of wear layers on top of the foil or web.

26. A process according to claim 25, wherein the wear layers are constituted of α-cellulose impregnated with a polymeric resin or lacquer selected from the group consisting of melamine-formaldehyde, urea-formaldehyde, polyurethane, acrylic and maleamid.

27. A process according to claim 25, wherein the wear layers are constituted of a lacquer selected from the group consisting of acrylic and maleamide.

28. A process according to claim 26, including the step of applying the lacquer in two or more layers with intemediate stages of partial or complete curing.

29. A process according to claim 25, wherein the lacquer includes 2-100 g/m² per layer of hard particles of a-aluminum oxide, silicon carbide or silicon oxide having an average particle size in the range 5 nm-150 μm.

30. A process according to claim 29, wherein the upper surface of the uppermost layer of lacquer contains 2-100 g/m² of hard particles of a-aluminum oxide, silicon carbide or silicon oxide having an average particle size in the range 50 nm-30 μm.

31. A process according to claim 1, including the step of applying a decor on the upper side of the at least first surface web or the upper side of the core and that the decor is printed directly on the surface or applied on the surface via transfer printing.

32. A process according to claim 31, including applying a wear layer or a number of wear layers on top of the decor.

33. A process according to claim 32, wherein the wear layers are constituted of Δ-cellulose impregnated with a polymeric resin or lacquer selected from the group consisting of melamine-formaldehyde, urea-formaldehyde, polyurethane, acrylic and maleamid.

34. A process according to claim 32, wherein the wear layers are constituted of a lacquer selected from the group consisting of acrylic and maleamide.

35. A process according to claim 33, including the step of applying the lacquer in two or more layers with intermediate stages of partial or complete curing.

36. A process according to claim 32, wherein the lacquer includes 2-100 g/m² per layer of hard particles of α-aluminum oxide, silicon carbide or silicon oxide having an average particle size in the range 50 nm-150 μm.

37. A process according to claim 32, wherein the upper surface of the uppermost layer of lacquer contains 2-100 g/m² of hard particles of α-aluminum oxide, silicon carbide or silicon oxide having an average particle size in the range 50 nm-30 μm.

38. The process according to claim 1, wherein the joining means on said edges include a tongue and groove joint.

39. The process according to claim 2, wherein the webs are bonded to one another at the same time the core is formed.

40. The process of claim 27, further comprising exposing the lacquer to UV- or electron-beam radiation to cure the lacquer.

41. The process of claim 40, further comprising exposing the lacquer to UV- or electron-beam radiation to cure the lacquer.
